(19) United States
(12) Patent Application Publication
(10) Pub. No.: US 2025/0034814 A1
(43) Pub. Date: Jan. 30, 2025

(54) EMBOSSING DEVICE FOR EMBOSSING A CELLULOSE WEB MATERIAL AND RELATED METHOD

(71) Applicant: Valmet Tissue Converting S.p.A., Lucca (IT)

(72) Inventors: Franco MONTAGNANI, Palaia (IT); Matteo GALOPPINI, Lucca (IT)

(73) Assignee: Valmet Tissue Converting S.p.A., Lucca, LU (IT)

(21) Appl. No.: 18/716,240

(22) PCT Filed: Dec. 5, 2022
(86) PCT No.: PCT/EP2022/084477

§ 371 Date: Jun. 4, 2024

(30) Foreign Application Priority Data
Dec. 7, 2021 (IT) 102021000030857

(51) Int. Cl. D21H 27/40; B31F 1/07; D21G 9/00

(52) U.S. Cl. CPC D21H 27/40; B31F 1/07; D21G 9/0036; B31F 2201/0707; B31F 2201/0779

(57) ABSTRACT

The embossing device includes one or more cameras with respective lighting and image acquiring systems to acquire images of one or more plies of the produced cellulose web material. The images can be used to detect any defect in the produced material and to alarm, or signal the need for intervention on an embossing device. Based on the defects on the product detected by processing the acquired images, it is also possible to directly intervene on functional units of the embossing device, to remove or reduce the defects.

### TECHNICAL FIELD

The present invention relates to the field of paper converting machines, particularly tissue paper converting machines. Embodiments disclosed herein relate to embossing devices, especially to embossing-laminating devices, used to emboss plies of cellulose material and to bond together a plurality of embossed plies to form a multi-ply embossed cellulose web material, i.e. a web material comprising at least two plies bonded to each other.

### BACKGROUND ART

In tissue paper production and converting, to produce products like rolls of toilet paper, kitchen towels, napkins, handkerchiefs, interfolded wipes and towels and the like, it is well known to unwind a plurality of plies of cellulose fibers from one or more master rolls, and to convert the cellulose plies into a semi-finished or finished product comprising one or more plies bonded together.

When producing a multi-ply web material, the plies of cellulose fibers are often bonded to one another by gluing or mechanical ply-bonding, i.e. by hard pressing the plies against one another. To this end, at least a ply of cellulose fibers is embossed through an embossing roller and a pressure roller that is typically coated with an elastically yielding material. Embossing permanently deforms the ply of cellulose fibers, forming embossed protuberances on it. The glue is applied to the embossed protuberances whilst the ply of cellulose fibers still adheres to the embossing roller. Then, a second ply is put over the embossed ply of cellulose fibers, and the two plies are pressed against each other in the areas where the glue has been applied, so as to make them adhere to each another.

Two or more plies, at least one of which is embossed, are then bonded together to form a multi-ply web material. The web material may be wound to form rolls, or cut and folded to form napkins, handkerchiefs and the like.

Broadly speaking, an “embossing device” is a device adapted to emboss at least one ply of cellulose material through an embossing unit comprising an embossing roller, provided with embossing protuberances, that co-acts with a pressure roller pressed against it. More specifically, within the context of embossing devices the term “embossing-laminating device” indicates a device configured to emboss at least one ply of cellulose material and to bond it to at least one second, embossed or non-embossed, cellulose ply.

In addition to make the plies of cellulose material adhere to one another, embossing is also useful for improving the quality of the multi-ply paper product. For example, when the plies of cellulose material are wound in rolls, it is possible to increase the thickness of each individual ply to increase the volume, or the diameter, of the finished product, if this latter is a roll. In other cases, it is possible to increase the absorption capacity or the softness of the finished product without decreasing, or not significantly decreasing, the mechanical strength, i.e. the tensile strength, of the plies.

For these reasons, many methods and machines have been developed for embossing plies of cellulose material, as disclosed in EP1075387, EP1855876, U.S. Pat. No. 3,556,907, EP1239079, EP1319748, and U.S. Pat. No. 6,746,558.

The quality of the embossed product constituted by the multi-ply web material depends on many factors and operating conditions of the embossing device. Adjusting the embossing device and keeping it perfectly efficient, so as to have a high-quality finished product, is a complex task, for which experienced staff is required.

The embossing devices are inserted in high-speed production lines, where the cellulose web material moves at speed higher than 200 m/min, up to 1000 m/min, based on the type of material processed. Because of the high speed of the production line, it is impossible to detect defects, in particular embossing defects, on the embossed web material while it moves along the feed path. The operator shall therefore look closely at the product when it exits from the line to understand whether the embossing device is working correctly or if any adjustment is required.

Production defects can be caused, for example, by an insufficient or excessive embossing of either of the plies processed in the embossing device. Further defects can be caused, for example, by a defective gluing of plies, that can result in delamination (i.e. detachment) of the plies, and a wrong positioning of the plies in multi-ply products which require the plies to be in phase.

In some cases, the production defects, due for example to a wrong adjustment of the embossing device, are detected only after a significant length of cellulose material has been processed, because of the high production speed of the lines and the impossibility of in-line checking the defects. The faulty semi-finished or finished product produced by an embossing device that does not work properly becomes a production waste, which shall be removed and recycled. This is a production cost that either affects the final price of the product or reduces the margin for the manufacturer.

Therefore, in the field of the invention it would be useful to have lines for converting cellulose plies comprising one or more embossing devices allowing to ensure immediate and, if possible, more accurate interventions aimed at reducing or eliminating the defects that result into production waste or low-quality finished products.

### SUMMARY

To solve at least partially the drawbacks of the prior art, an embossing device is provided, which comprises a first embossing roller, equipped with a plurality of first embossing protuberances, and a first pressure roller, defining, with the first embossing roller, an embossing nip, through which a first feed path extends for feeding a first cellulose ply. A first actuator is adapted to push the first embossing roller and the first pressure roller against each other to emboss a first cellulose ply. The embossing device also comprises an exit path for an embossed web material including the first embossed cellulose ply. Characteristically, a first vision unit is provided along the exit path to acquire images of at least one face of the embossed web material. The first vision unit comprises a first camera, in particular adapted to detect defects in the embossed web material, in particular embossing defects. In some embodiments, the camera can be adapted to detect also gluing defects, in particular when the web material comprises a plurality of plied bonded by gluing.

In the present description and the attached claims, the term “camera” refers to any device adapted to acquire images of a cellulose ply. The camera is preferably a digital device acquiring digital images of the cellulose ply.

The pressure roller can be a rigid roller, the stiffness of which is the same of the embossing roller, adequately engraved to engage the embossing protuberances of the embossing roller. In preferred embodiments, the pressure roller is coated with a yielding material, preferably an elastically yielding material, such as natural or synthetic rubber, so as to be deformed by the pressure between embossing roller and pressure roller.

The vision unit allows to promptly detect any defect in the web material exiting from the in embossing device and to provide the operator with related information. As it will be described below in greater detail, with a self-learning or AI system it is also possible to detect, at least at statistical level, the possible causes of the defects and to provide the operator with indications on the interventions to be performed on the embossing device for reducing or eliminating the defects. In particularly advantageous embodiments, to automatically adjust one or more operating parameters for reducing or removing the detected defects, a control unit can be interfaced with one or more functional units of the embossing device, the control unit receiving pieces of information from the detected images.

In the simpler embodiment of the invention, the embossing device comprises only one feed path for feeding a (single or multiple) ply of web material; however, in currently preferred embodiments the embossing device comprises also a second feed path, for feeding a second cellulose ply, and a bonding arrangement, for bonding the first embossed cellulose ply to the second cellulose ply. In this way, web material can be produced comprising at least two plies, at least one of which is embossed, wherein the other one can be smooth or embossed. In case both plies are embossed, they can be embossed separately along two different feed paths, to obtain a very thick multi-ply web material, wherein the embossing patterns of the two plies are chosen so as to achieve the required technical-functional features on the finished product.

In embodiments described herein, to produce a multi-ply web material with at least two plies embossed separately and then bonded together, the embossing device comprises a second embossing roller, equipped with a plurality of second embossing protuberances, and a second pressure roller defining, with the second embossing roller, a second embossing nip, through which a second feed path extends for feeding the second cellulose ply. A second actuator can be provided to press the second embossing roller and the second pressure roller against each other.

The two or more plies forming the multi-ply embossed web material can be bonded together for example by mechanical ply-bonding systems. These can include mechanical ply-bonding wheels. In other embodiments, the plies are bonded together through a functional fluid. In this case, the embossing device can comprise an applicator for applying a functional fluid, for example water or steam, or a glue, for bonding the first cellulose ply, fed through the first embossing nip, to the second cellulose ply, fed along the second feed path.

In further embodiments, the functional fluid applicator co-acts with the first embossing roller.

To promote the bonding of the two, or more, cellulose plies, the embossing device can comprise a lamination nip, adapted to receive the first embossed cellulose ply and the second cellulose ply and to bond the first embossed cellulose ply to the second cellulose ply. The lamination nip can be formed between two members pressed against each other. In embodiments described herein, one of the two members is the first embossing roller. The second member can be a second embossing roller, for example if the embossing device is in tip-to-tip configuration. In this case, the lamination nip can be constituted by the nip formed between the first embossing roller and the second embossing roller. In further embodiments, the lamination nip can be formed between the first embossing roller and a lamination device, constituted for example by a plurality of pressure wheels or disks, or by a lamination roller. The lamination roller may have a smooth surface. In some embodiments the lamination roller can be made of steel, in other embodiments it can be coated with an elastically yielding coating, which is stiffer than the yielding coating of the first pressure roller and of the second pressure roller, if any.

In some embodiments, the first vision unit is provided opposite the first embossed cellulose ply to acquire images of the first embossed cellulose ply.

Advantageously, especially if the embossing device comprises a second feed path, a second vision unit, comprising a second camera, can be provided along the exit path of the web material, on a side opposite the first vision unit.

In some embodiments, the first camera of the first vision unit and the second camera of the second vision unit are aligned in such a way that a first optical axis of the first camera and a second optical axis of the second camera match. This allows to efficiently detect any displacements between the embossing patterns formed on the first cellulose ply and those formed on the second cellulose ply.

To reduce disturbance of environmental light radiations to the cameras of the vision unit(s) acquiring the images, the vision units can be housed in opaque containers or casings, i.e. containers or casings that are not transparent, having inlet and outlet slots for the web material. In some embodiments a single container or casing can be provided for all the vision units. The container or casing is opaque to the wavelengths used by the cameras. The wavelengths used by the cameras can be within the visible spectrum and (also) in different ranges, for example in the near-infrared region.

A method is also disclosed herein, for producing a web material including at least one ply embossed by an embossing device, the method comprising the following steps:
a. feeding a first cellulose ply along a first feed path through a first embossing nip between a first embossing roller, equipped with a plurality of first embossing protuberances, and a first pressure roller; wherein the first embossing roller and the first pressure roller are pressed against each other by a first actuator;
b. feeding an embossed web material, including the first embossed cellulose ply, towards an exit path;
c. acquiring images of the first embossed cellulose ply through a first vision unit that is provided along the exit path for the embossed web material and comprises a first camera.

In currently preferred embodiments, the method further comprises the steps of: feeding a second cellulose ply along a second feed path; bonding the first embossed cellulose ply and the second cellulose ply together.

### BRIEF DESCRIPTION OF THE DRAWING

The invention will be better understood by following the description below and the attached drawing, showing a non-limiting embodiment of the invention. More specifically, in the drawing:

FIG. 1 is a schematic side view of an embossing device in an embodiment;

FIGS. 1A, 1B show enlargements of a detail of the cylindrical surfaces of the embossing rollers;

FIG. 2 is a diagram of a system for varying the orientation of one of the pressure rollers;

FIG. 3 is a schematic plan view of a vision unit;

FIG. 4 is a front view according to IV-IV in FIG. 3; and

FIGS. 5A-5G show images of the web material acquired by the vision unit in different operating conditions, without and with defects of various type.

### DETAILED DESCRIPTION

Briefly, to improve the performances of an embossing device, at least one video- or TV-camera is provided at the exit of the embossing device to acquire images of at least one side or face of the embossed cellulose web material exiting from the embossing device. The camera can be either integrated or interfaced with a control unit adapted to process the acquired imaged and to extract from the images information useful to detect production defects, if any. According to the invention, it is also possible, if necessary based on comparisons with previously stored images, to classify the detected defects, i.e. to identify one or more causes for the defects, and to propose an operator, or to directly perform, one or more interventions on the embossing device, aimed at reducing or eliminating the defects.

In the detailed description below, reference will be made to an embossing device, more precisely to an embossing-laminating device of the so-called nested or DESL type, with a double embossing unit, each of which comprises an embossing roller and a pressure roller, to separately emboss two cellulose plies. Then, a lamination roller bonds the embossed plies together, after having applied a functional fluid, for example water, or a glue. However, many innovative aspects described herein can be also applied to embossing devices of different type, for example of the “tip-to-tip” or “embossing-gluing” (goffra-incolla) type, and in particular to embossing devices where even only one individual ply can be embossed and/or where more than two plies can be bonded together in various ways. Innovative aspects described herein can be used also for improving simple embossing devices, i.e. devices that emboss one or more plies along a single feed path and comprise only one embossing roller and one pressure roller.

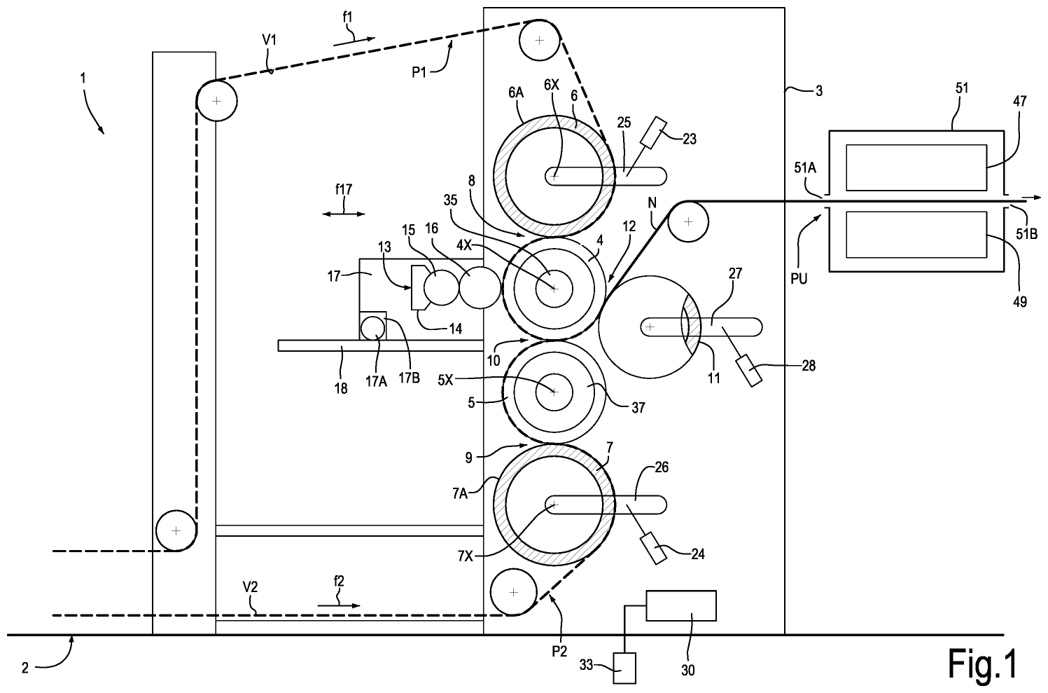

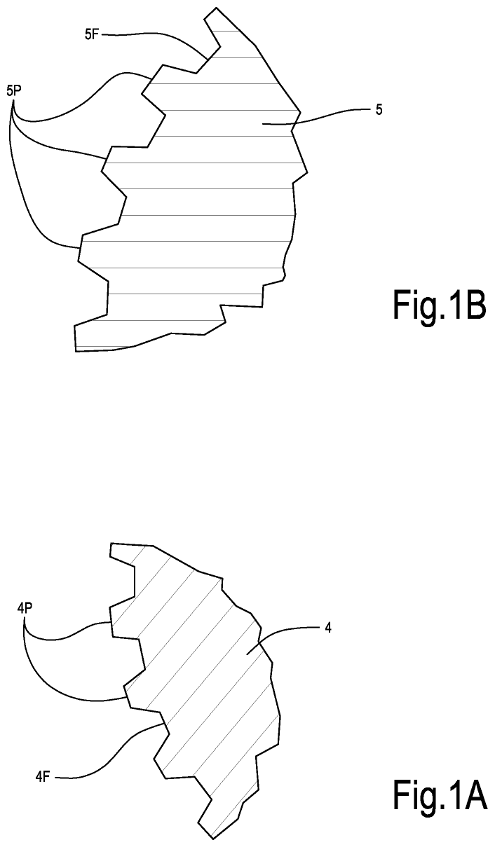

With reference to the embodiment illustrated in FIG. 1, the embossing device 1 has a bearing structure indicated as a whole with the reference 2. The bearing structure can comprise two side flanks 3, between which the rollers and the paths for the cellulose plies are provided, as described below.

In some embodiments, a first embossing roller 4 and a second embossing roller 5 can be provided between the two side flanks 3 of the bearing structure 2. The first embossing roller 4 can be provided with embossing protuberances 4P, as shown in the enlarged detail of FIG. 1A, and the second embossing roller 5 can be provided with embossing protuberances 5P, as shown in the enlargement of FIG. 1B. The bottom surface of the embossing roller 4, 5 can be defined as the surface of the roller that separates the bases of the embossing protuberances 4P, 5P, and is indicated with the reference 4F, 5F. The surface 4F, 5F is generally smooth. In case of double-height embossing protuberances, the base surface of the embossing roller is the surface that separates the bases of the shorter protuberances.

The first embossing roller 4 can co-act with a first pressure roller 6. In some embodiments, the pressure roller 6 can be coated with an outer layer 6A made of a yielding material, preferably an elastically yielding material, for example rubber. The second embossing roller 5 can co-act with a second pressure roller 7. In some embodiments, also the pressure roller 7 can be coated with an outer layer 7A made of a yielding material, especially an elastically yielding material.

The references 4X, 5X, and 6X, 7X indicate respectively the rotation axes of the two embossing rollers 4, 5 and of the two pressure rollers 6, 7. These axes are substantially parallel. In some embodiments, the axes 4X, 6X can be adjustable so as to be arranged slightly skewed, i.e. not parallel, to change the conditions of, and to balance any non-uniformity in, the mutual contact between the central area and the end areas of the rollers 4, 6. Analogously, the axes 5X, 7X can be adjustable so as to be arranged slightly skewed, i.e. not parallel, to change the conditions of, and to balance any non-uniformity in, the mutual contact between central area and end areas of the rollers 5, 7.

Between the first embossing roller 4 and the first pressure roller 6 a first embossing nip 8 is formed; through the nip 8, a first feed path P1 extends, along which a first ply V1 moves forward for being embossed by the protuberances 4P of the first embossing roller 4. If the pressure roller 6 has an outer yielding coating 6A, the protuberances 4P are pressed against the first pressure roller 6 and penetrate the yielding coating 6A, thus permanently deforming the ply V1.

Between the second embossing roller 5 and the second pressure roller 7 a second embossing nip 9 is formed, where through a second feed path P2 extends, along which a second ply V2 moves forward. The second ply V2 is embossed in a way analogous to that of the first ply V1, i.e. through the protuberances 5P of the second embossing roller 5 that are pressed against the second pressure roller 7. If the latter is provided with an elastically yielding coating 7A, the embossing protuberances 5P penetrate the yielding coating 7A, thus permanently deforming the ply V2.

To exert the necessary pressure between the pressure rollers 6, 7 and the respective embossing rollers 4, 5, a first actuator 23 can be provided for the first pressure roller 6 and a second actuator 24 can be provided for the second pressure roller 7. In practical embodiments, the first pressure roller 6 can be supported by a pair of arms 25 hinged to the flanks 3 and stressed by the first actuator 23, and the second pressure roller 7 can be supported by a pair of arms 26 hinged to the flanks 3 and stressed by the second actuator 24.

The actuators 23, 24 can be hydraulic cylinder-piston actuators or other suitable actuators. Instead of arms hinged to the flanks 3, other movable support members can be provided, allowing the movement of the pressure rollers 6, 7 toward and away from the embossing rollers 4, 5.

In some embodiments, not shown, the two embossing rollers 5, 6 can be configured to operate tip-to-tip, i.e. with the protuberances 4P, 5P pressed against one another or anyway arranged at a mutual distance between the heads of the protuberances that is smaller than the thickness of the plies, in a nip 10 formed between the two embossing rollers 4, 5. In this case, the nip 10 constitutes a lamination nip.

In other embodiments, the embossing device 1 can comprise, as shown in FIG. 1, a lamination roller 11, pressed against the first embossing roller 4 and forming a lamination nip 12 therewith. In this way, the two plies V1 and V2 can be laminated between the first embossing roller 4 and the lamination roller 11. In the nip 10, formed between the embossing rollers 4, 5, these latter are slightly spaced from each other, and the protuberances that they form on the plies V1 and V2 can be mutually staggered. In this case, the embossing device can produce a material embossed according to the so-called nested technique, i.e. with embossing protuberances of the ply V2 nested between embossing protuberances of the ply V1, and vice versa.

In some embodiments, the embossing device 1 can be configured to alternatively operate according to the tip-to-tip technique or to the nested technique. To this end, the embossing rollers can be movable parallel or orthogonally to their axes, and the lamination roller can be alternatively movable between an active position and an idle position. To this end, the lamination roller 11 can be supported by arms 27 hinged to the flanks 3, and can be associated with an actuator 28 that can either move the lamination roller 11 away from the first embossing roller 4, or press it (if necessary, with variable pressure) against the first embossing roller 4.

The embossing device 1 can comprise a functional fluid applicator 13 associated with the first embossing roller 4. The functional fluid applicator 13 is a device adapted to apply a liquid or gaseous fluid to the ply V1, the fluid being adapted to promote, to facilitate or to perform the mutual adhesion of the plies V1 and V2.

The functional fluid applicator 13 may apply saturated or unsaturated steam, to facilitate the mutual adhesion of the plies V1 and V2 through pressure. In currently preferred embodiments, as shown in FIG. 1, the functional fluid applicator 13 can comprise a liquid source 14, a first screened roller or anilox roller 15 that takes the liquid from the liquid source 14, and a second plate roller or application roller 16 that receives the liquid from the screened roller 15 and distributes it on portions of the embossed ply V1 adhering to the first embossing roller 4. The liquid is generally applied, at at least some heads of the embossing protuberances 4P, the first embossing roller 4 is provided with, on the portions of ply embossed by means of the embossing protuberances 4P. The liquid can be water or glue. If the liquid is water, the adhesion of the plies is performed mainly through mechanical pressure.

When the embossing device 1 is operating, the first ply V1 and the second ply V2 move forward according to the arrows f1 and f2 along the first feed path P1 and along the second feed path P2 towards the embossing rollers in 4, 5 and the embossing nip 8, 9, to be separately embossed between the pairs of rollers 4, 6 and 5, 7. The embossed plies V1, V2 are glued and laminated between the embossing roller 4 and the lamination roller 11, and consequently form an embossed web material N (in the illustrated example a multi-ply web material) that moves forward according to the arrow fN along an exit path PU towards a downward station, for example a rewinding station or an interfolding machine, not shown.

For respectively embossing the two plies V2 and V1, the pressure roller 7 is pressed against the embossing roller 5 and the pressure roller 6 is pressed against the embossing roller 4; and the lamination roller 11 is pressed against the embossing roller 4 to bond the plies V1, V2 to each other.

In some embodiments, the functional fluid applicator 13 is mounted on a slide or carriage 17 that can be movable according to the double arrow f17, for example along guides 18 carried by an element of the bearing structure 2. The movement according to the double arrow f17 can be controlled by a suitable actuator, for example a cylinder-piston actuator, an electric motor, or any other adequate actuator. In FIG. 1 a pinion 17A is schematically shown, which engages a rack integral with the guides 18 and is driven into controlled rotation by an electric motor 17B, integral with the slide or carriage 17.

The embossing device 1 can comprise a control unit 30, for example a computer, a micro-computer, a PLC or the like, which can be adequately coupled, either directly or indirectly, to a user interface 33. The interface can include, for example, one or more of the following components: monitor, display, touch pad, mouse, keyboard, and/or other apparatuses adapted to give information to an operator and/or to receive instructions, controls, data or settings from an operator. The interface can be coupled to the control unit 30 through a wireless or wired connection. The interface can be a remote device connected to the network (wired or wireless connection), which allows monitoring the embossing device 1 remotely.

The control unit 30 can be suitably interfaced with some or all the actuators of the embossing device 1 and any other sensor, encoder, probe, detector or any other apparatus of the embossing device 1 for acquiring data. The control unit 30 can also be interfaced with further control units of the same level, or of higher or lower level, associated with the converting line that comprises the embossing device 1.

Particularly, the control unit 30 can be interfaced with the actuators 23, 24, 28 and, if necessary, with load cells or other sensors adapted to detect the force with which the pressure rollers 6, 7 and the lamination roller 11 are pressed against the respective embossing rollers 4, 5.

In some embodiments, the control unit 30 can be connected to a system for driving into rotation the embossing rollers 4, 5, to control and to modulate the rotation speed and the mutual angular phase of the embossing rollers 4, 5, for purposes that will be described below. In the diagram of FIG. 1, the references 35 and 37 respectively indicate a motor for the rotation of the first embossing roller 4 and a motor for the rotation of the second embossing roller 5. The two motors 35, 37 are schematically shown aligned with the axis of the embossing rollers 4, 5, but this is not mandatory.

The motors 35, 37 can be electronically controlled and coupled to devices for detecting the angular position, for example absolute angle encoders, to allow adjusting the mutual angular position of the embossing rollers, for the reasons and purposes that will be clearly apparent from the description below. The motors 35, 37, and the respective encoders or other sensors for detecting the angular position, can be directly or indirectly interfaced with the control unit 30.

As known to those skilled in the art, embossing requires accurate adjustment of the embossing members, and in particular accurate regulation of the pressure exerted by the pressure rollers 6, 7 and by the lamination roller 11 against the respective embossing rollers 4, 5. If the embossed web material N is of the nested type, it is also necessary to correctly adjust the mutual angular and axial positions of the embossing rollers 4, 5 to avoid staggering, in cross direction or in machine direction (feed direction of the cellulose plies V1, V2), of the embossing patterns generated by the two embossing units formed by the pairs of rollers 4, 6 and 5, 7.

In addition, it is useful to provide for further regulations that take into account any deformation of the embossing rollers 4, 5 and/or of the pressure rollers 6, 7 due to the effect of the weight thereof and/or of the forces applied by the actuators 23, 24. In fact, the embossing rollers and the pressure rollers can be deformed, due to the forces acting thereon, in such a way that the axes thereof form camber different than zero. When this occurs, embossing is no longer uniform across the central area and the side area of any or both of the cellulose plies V1, V2. To remedy this defect, the prior art provides for introducing an angle of mutual inclination between the rotation axis of an embossing roller 4, 5 and the axis of the respective pressure roller 6, 7. In practice, to avoid that the cellulose ply V1 or V2 is less embossed in the central area than in the side areas, the rotation axes of the embossing roller 4 or 5 and of the respective pressure roller 6 or 7 are arranged slightly skewed.

To this end, for example, at least one of the two supports of the respective embossing roller 4 or 5 can be housed in a seat supported by the respective flank 3, the seat being so configured as to allow a controlled displacement of the rotation axis of the embossing roller. To this end, the seat can have, for example, such an eccentricity that the rotation thereof relative to the flank 3 implies a change in the angular position of the rotation axis 4X or 5X of the embossing roller 4 or 5. An actuator can be provided to control the change in the inclination of the rotation axis 4X or 5X of the embossing roller 4 or 5.

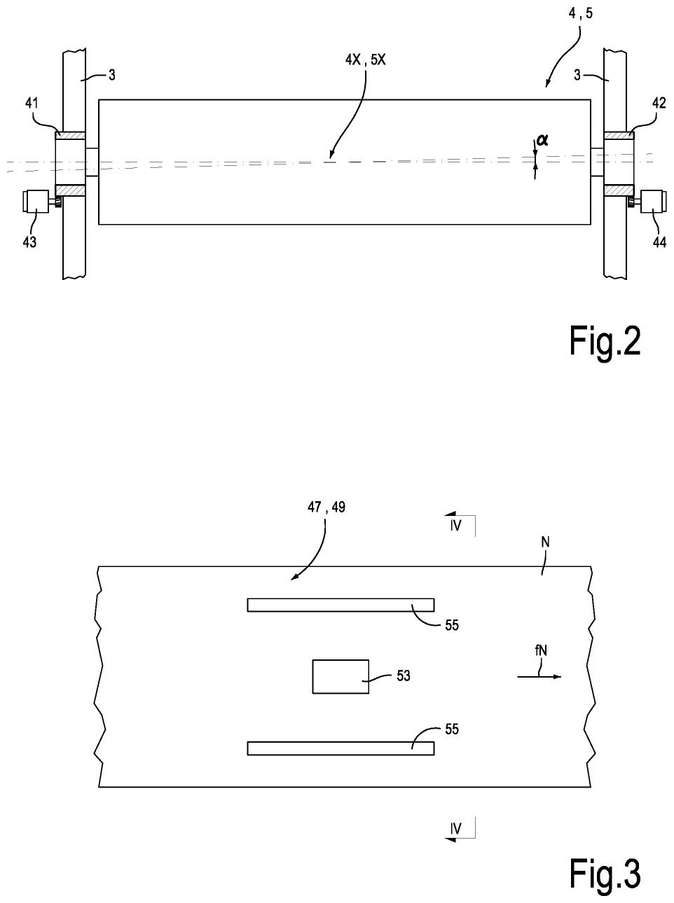

In FIG. 2 an arrangement of this type is schematically shown, that can be adopted for both the embossing roller 4 and the embossing roller 5. The references 41 and 42 indicate respective seats for support bearings of the embossing roller 4 or 5. The seats 41 and 42 are housed in the flanks 3. The seats 41, 42 can rotate around axes orthogonal to the flanks 3, for example through a pair of electric motors 43, 44, to change the inclination of the rotation axis 4X or 5X of the embossing roller 4 or 5. The symbol a indicates the angle of inclination of the rotation axis 4X, 5X relative to a position where the axis 4X, 5X is parallel to the rotation axis 6X, 7X of the corresponding pressure roller 6, 7.

In practice, the motors 43, 44 constitute an actuator to change the mutual inclination of the rotation axes 4X, 6X and 5X, 7X of the embossing rollers 4, 5 and the respective pressure rollers 6, 7, in such a way that the rotation axes are slightly skewed suitably to correct any embossing defect due to a camber of any one of the embossing rollers and the pressure rollers.

The embossing device 1 may comprise, instead of or in addition to a system of the type shown in FIG. 2, which controls and changes the angle of mutual inclination between the axes of the embossing rollers and of the respective pressure rollers, a system for adjusting the crowning of the pressure rollers. A device of this type is disclosed for example in U.S. Pat. No. 7,645,222, whose content is incorporated herein by reference.

The actuators described above can be interfaced with the control unit 30 so that this latter can control, change, adjust one or more of the following:
the pressure between the first embossing roller 4 and the first pressure roller 6, and therefore the embossing depth of the first cellulose ply V1;
the pressure between the second embossing roller 5 and the second pressure roller 7, and therefore the embossing depth of the second cellulose ply V2;
the lamination pressure between the lamination roller 11 and the first embossing roller 4;
the angular position of the rotation axis of the first pressure roller 6 relative to that of the rotation axis of the first embossing roller 4;
the angular position of the rotation axis of the second pressure roller 7 and of the second embossing roller 5;
the angular phase between the first embossing roller 4 and the second embossing roller 5;
the position of the slide 17 carrying the functional fluid applicator 13;
the conditions of supply of the functional fluid, for example by changing the mutual position or the relative speed between the components 14, 15, 16 of the functional fluid applicator 13; to this end one or more actuators (not shown) can be provided, adjusting the position and/or the speed of the components 14, 15, 16 of the functional fluid applicator 13.

A first vision unit 47 is provided along the exit path PU for the web material N; the first vision unit faces the embossed cellulose ply V1 and is adapted to acquire images thereof.

In the embodiment illustrated in FIG. 1, a second vision unit 49 is provided along the exit path PU; the second vision unit faces the embossed cellulose ply V2 and is adapted to acquire images thereof. The two vision units 47, 49 are preferably provided in the same position. The two vision units 47, 49 are advantageously housed in a container or casing 51 that is opaque to the operative wavelengths of the cameras with which the two vision units 47, 49 are equipped. The wavelengths can be within the visible spectrum or outside it, for example in the infrared or ultraviolet region, typically in the near-infrared or near-ultraviolet regions.

The container or casing 51 can have an inlet slot 51A and an outlet slot 51B for the web material N.

The container or casing 51 shields from outer environmental radiations, such as sun light or artificial lights. In this way, better conditions are achieved for the vision and acquisition of images of the two sides or faces of the web material N.

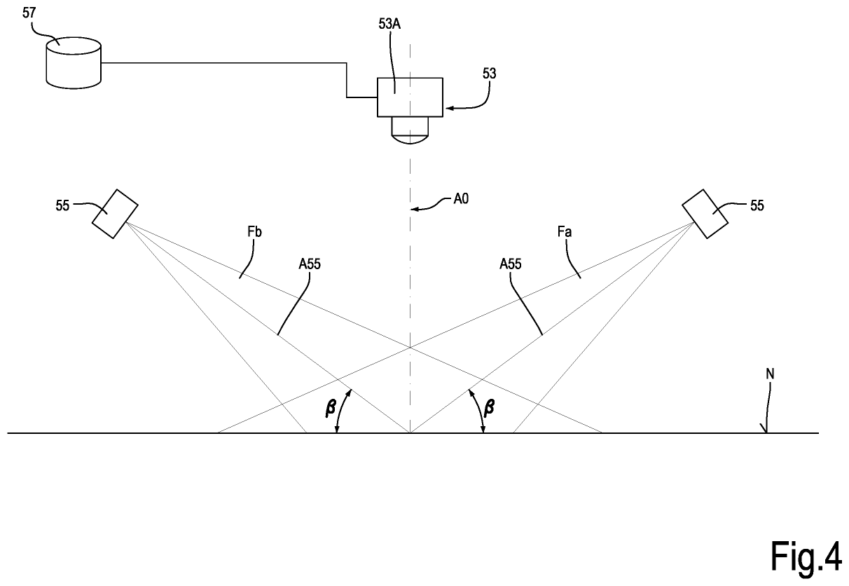

FIGS. 3 and 4 show a diagram of the two vision units 47, 49, that can be equal to each other. In the illustrated embodiment, each vision unit 47, 49 comprises a camera 53 and a lighting system. In the illustrated example, the lighting system includes two lighting units 55. Each lighting unit 55 comprises, in the illustrated example, a lighting bar extending parallel to the web material N and parallel to the feed direction of the web material N along the exit path PU. Each lighting bar 55 may comprise a matrix of LEDs or other lighting means.

As shown in FIG. 4, the lighting bars 55 are inclined so as to light, with two beams Fa, Fb inclined by an angle β relative to the plane where the web material N lies, a surface portion of the respective cellulose plies V1 and V2 arranged opposite the camera 53. The two beams Fa and Fb are preferably symmetrical relative to a plane that is orthogonal to the surface of the web material N and contains the optical axis AO of the camera 53. In other embodiments, the two beams Fa, Fb are not symmetrical.

In the illustrated embodiment, the two beams Fa and Fb have axes A55 converging in a point laying on the plane where the web material N lies and coinciding with the incidence point of the optical axis AO on the plane.

This arrangement makers the lighting system significantly efficient, thus allowing to easily detect embossing defects, even small defects, by analyzing the images acquired by the camera. In particular, this arrangement of the light sources allows to detect efficiently and accurately even very small variations in the embossing depth, i.e. the depth of the embossed protuberances generated by permanently deforming the cellulose ply. This is particularly useful to verify whether the embossing pressure is right or shall be adjusted.

In this way it is possible, for example, to keep the quality of the finished product constant even if several operating parameters change. In fact, the embossing depth of the cellulose ply may vary even if the embossing pressure remains constant, for example because of the temperature of the pressure roller. Namely, the mechanical features of the elastically yielding coating of the pressure roller may vary, the stiffness thereof being reduced as the temperature increases. The embossing depth may also vary due to changes in the thickness of the cellulose ply, or to the composition thereof, or to other factors that cannot be easily controlled.

Therefore, keeping the pressure between embossing roller and pressure roller constant is not enough to ensure a constant embossing depth of the cellulose ply.

Furthermore, the penetration of the embossing protuberances of an embossing roller into the elastically yielding coating of the respective pressure roller could be non-uniform along the whole area of contact between embossing roller and pressure roller. In particular, the embossing depth can be smaller in the central area and greater in the side areas of the cellulose ply due to deformation of the rollers generating a camber of the rotation axis. The embossing depth can be also affected by a change in the temperature of the rollers, in particular of the pressure rollers 6, 7 if coated with an elastically yielding material. In fact, at higher temperatures the elastically yielding material is softer and penetrates more easily between the protuberances 4P and 5P. When this condition occurs, it is necessary to reduce the embossing pressure.

Therefore, a lighting system that allows to detect precisely and promptly even small changes in the embossing depth is significantly advantageous.

The optical axis AO of the camera 53 can be substantially orthogonal to the surface of the respective ply V1 and V2. The two cameras 53 of the two vision units 47, 49 may coincide.

Each camera 53 can be equipped with a processing unit 53A that processes the acquired images, for example to compare them with images that have been previously stored in a memory 57. The previously stored images can be images reproducing a web material N devoid of defects, or with defects within a tolerance interval. The processing units 53A of the cameras 53 can be programmed to get, from the comparison between the acquired images and the stored images, information on the type of defect detected on the respective ply V1 and V2 of the web material N.

Instead of using cameras 53 equipped with processing units 53A, the images acquired by the cameras 53 can be sent to and processed by the control unit 30. Combined, hybrid or intermediate solutions are also possible, where the control unit 30 and the processing units 53A process the images in combined or distributed fashion, i.e, wherein the control unit performs for example functions that are integrative to the functions performed by the processing units. In some cases, the same processing units 53A can constitute the control unit 30, or are part of the control unit 30.

It has been found that vision units like those disclosed herein are capable of detecting embossing defects of various type and origin with greater precision and promptness than those of a skilled human operator. The vision units not only allow a continuous control of the embossing conditions, and are thus able to promptly detect any defect; they are also capable of detecting defects, for example embossing depth defects, that are not visible to the naked eye.

In practice, each vision unit 47, 49 can include more than one camera 53 and respective lighting systems. The cameras of each vision unit can be transversally aligned for acquiring images of the whole width of the web material N, even if this is not always necessary. It could be sufficient, for example, to provide one camera, with the respective lighting system, in the central area of the web material N, and two vision systems along the edges of the web material N.

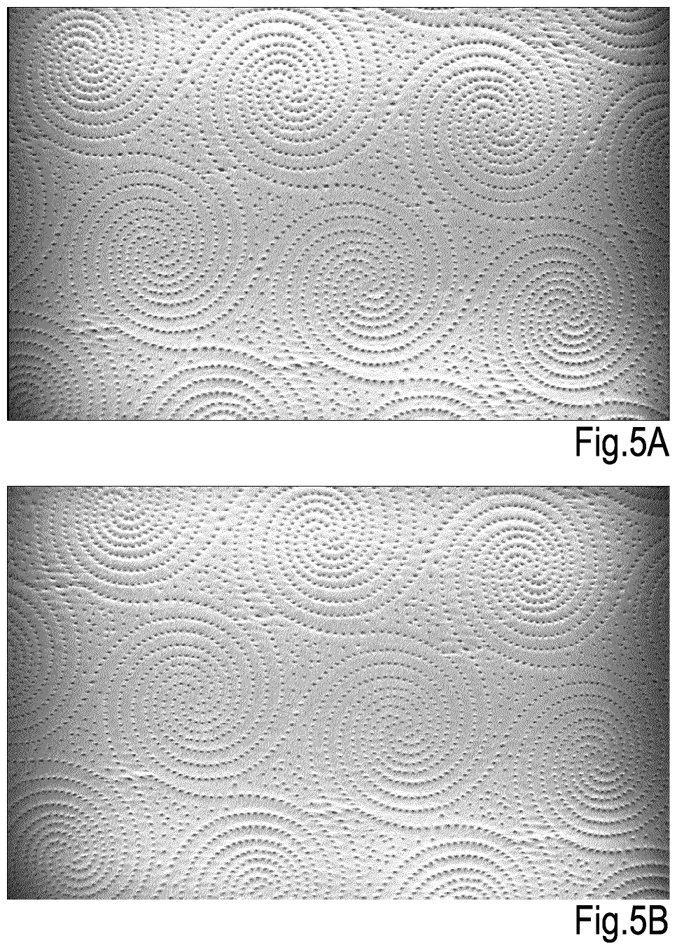

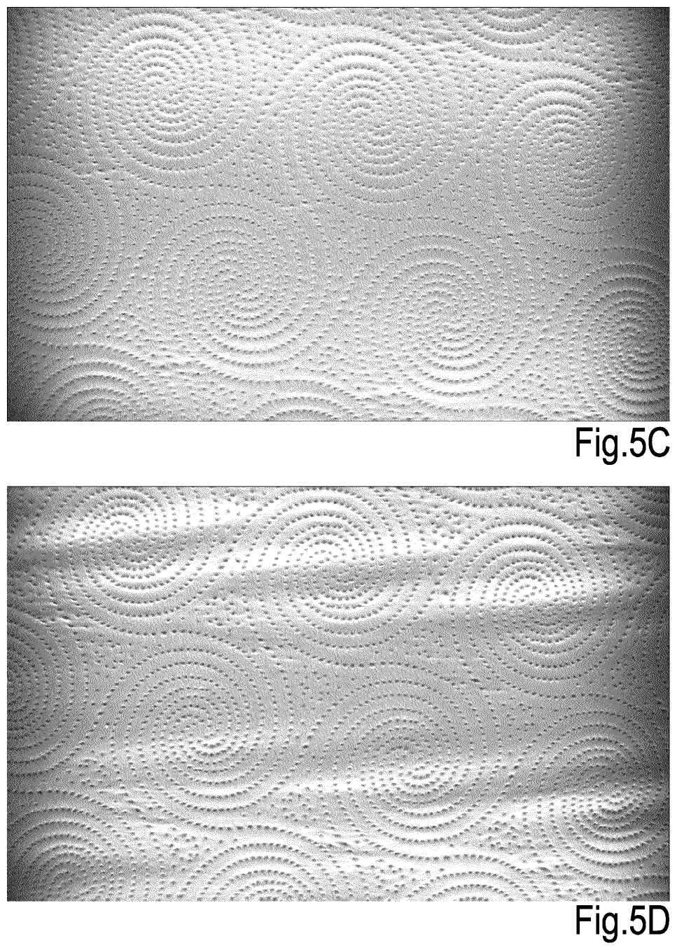

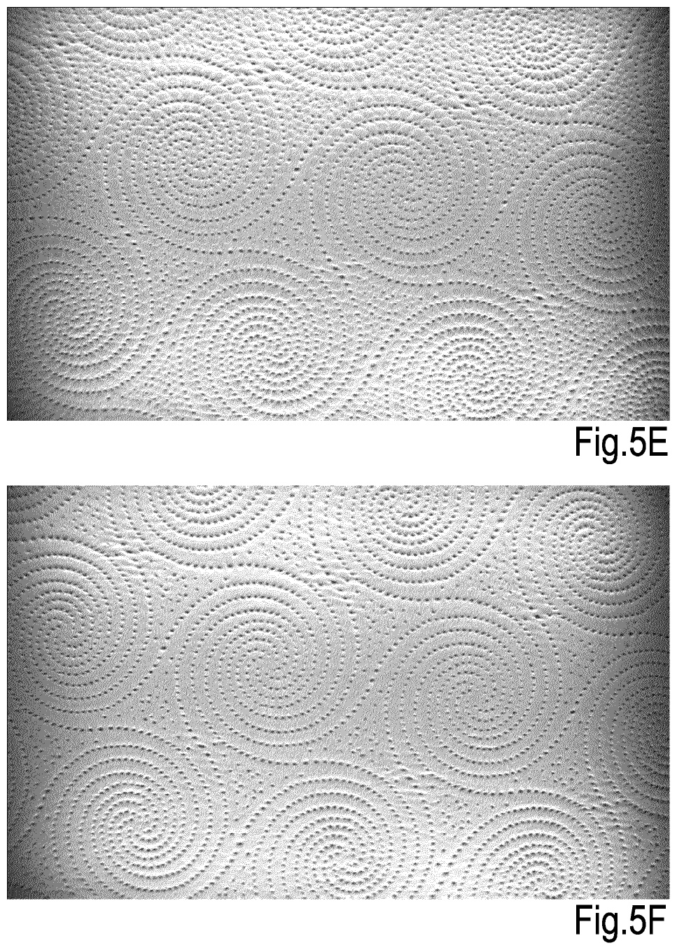

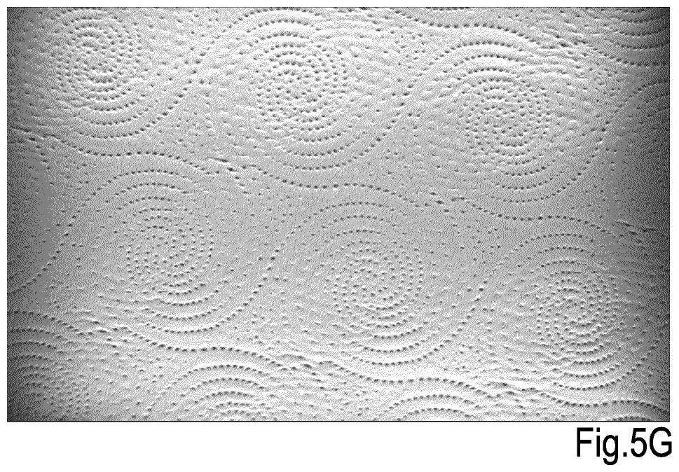

The sensitivity of a vision system of this type can be appreciated in particular looking at FIGS. 5A-5G, which show images of the web material N comprising the two embossed cellulose plies V1, V2 bonded to each other by gluing and lamination.

More in particular, FIG. 5A shows a correctly embossed ply V1, i.e. with the correct embossing depth. FIG. 5B shows the same web material N but with an embossing depth slightly smaller than the depth set. The difference is practically invisible to the naked eye, but is easily detected by the system comprising the vision unit described above. FIG. 5C shows an image, analogous to that of FIGS. 5A and 5B, where the embossing depth is even smaller. In this case, the difference with respect to the right embossing depth (shown in FIG. 5A) is visible to the naked eye, but with difficulties and only making a direct comparison with the image of FIG. 5A and that of FIG. 5B kept static, i.e. still. The described vision system is instead capable of detecting the defect in the image of FIG. 5C in a rapid and prompt manner, as the defected web material N exits the lamination nip.

Using suitable comparing algorithms and, if necessary, a self-learning and AI system, it is possible not only to detect the defect of FIGS. 5B and 5C, but also to identify the cause thereof. In other words, the processing unit 53A (or the control unit 30) is capable of signaling an anomaly and classifying it as insufficient embossing depth, for example through comparison with reference images stored in the memory 57.

An insufficient embossing depth, i.e. a too small depth of the embossed protuberances formed in the ply V1 (or V2) of the web material N, can be corrected by increasing the pressure between the respective embossing roller 4 or 5 and the respective pressure roller 6 or 7. The corrective intervention can be performed by an operator through the user interface 33, upon instruction from the control unit 30. Alternatively, or in combination, the control unit 30 can intervene autonomously controlling the actuator 23 or 24 for increasing the embossing pressure.

On the contrary, if the defect consists of a too deep embossing, the reverse can be done (manually or automatically).

The embossing depth should be as uniform as possible across the entire width of web material N, i.e. in transversal direction relative to the machine direction (arrows f1, f2, fN). A non-uniform depth in transversal direction can be due to the fact that the force exerted by the two arms 25 or 26 supporting the two pressure rollers 6, 7 is not balanced; it can be also due to the deformation of any of the embossing rollers 4, 5 or pressure rollers 6, 7 caused by the load applied and/or the weight of the same rollers. As mentioned above, these deformations can lead to a deformation camber and to a consequent reduction in the embossing depth in the central area of the web material.

At least one of the vision units 47, 49 can be configured to detect a lack of uniformity, i.e. a difference in the embossing depth between the central area and the side areas of the web material N. For example, one or both of the vision units 47, 49 can have cameras to acquire images in the central area and in the side areas of the web material N.

When, by analyzing the acquired images, a defect is detected due to a deformation camber or any other causes, with a lack of uniformity in the embossing depth between the central area and the side areas of the web material, the control unit 30 can inform the operator about the defect through the user interface 33, or can (alternatively or in combination) impart controls to correct the defect. When an actuator 43, 44 is provided for changing the angle of mutual inclination of the rotation axes of a pressure roller and of the respective embossing roller, the control unit 30 can impart a control to the actuator for correcting the inclination. Alternatively, the force exerted by the actuators 23, 24 can be changed.

The presence of two opposite vision units allows to verify embossing defects of this type on both plies V1 and V2 and to consequently adjust any of the two embossing units 4, 6 and 5, 7, respectively.

Instead of, or in addition to changing the mutual inclination of the rotation axes, to achieve the same result a system can be provided for changing the crowning of one or more of the embossing rollers and/or the pressure rollers, controlled by the control unit 30.

Other defects of the web material N can arise for example in the gluing step. FIG. 5D shows the same web material N of FIGS. 5A, 5B, 5C, with a gluing defect, due for example to an insufficient quantity of functional fluid (glue) and/or to a wrong distribution thereof. In some cases, the gluing defect can occur, for example, on only one face of the web material N. This occurs, for example, if the contact between plate roller 16 and embossing roller 4 is not uniform along the whole axial extension of the rollers, due to a lack of parallelism or other reasons.

The control unit 30 can either inform the operator about the gluing defect and/or correct it automatically by acting on the functional fluid applicator 13. If the gluing is different between the center area and the side area, or between the two edges, the mutual position of the embossing roller 4 and the functional fluid applicator 13 can be changed by changing the inclination of the axes of the rollers of the functional fluid applicator 13 relative to the axis of the embossing roller 4. Alternatively, or in combination, it is possible to control the functional fluid applicator, moving it toward or away from the embossing roller 4. Alternatively, or in combination, it is possible to change the inclination of the axis of the embossing roller 4. In case of a gluing defect on the whole width of the web material N due to an excessive or insufficient quantity of applied glue, it is possible to modify the quantity of glue by changing the relative peripheral speed of the rollers 15, 16 by changing the center-to-center distance between the rollers 15, 16 and 4, or in other suitable manner.

FIG. 5E shows one further defect that can occur on the web material N. The defect is, in this case, the re-embossing of the web material N in the lamination nip 12. Re-embossing can be due to an excessive pressure of the lamination roller 11 against the first embossing roller 4. When the control unit detects a defect of this type, the operator can be warned and invited to reduce the lamination pressure, for example by acting on the actuator 24. Alternatively, or in combination, the control unit 30 can directly act by reducing the pressure in the lamination nip 12.

The defect shown in FIGS. 5F and 5G is a lack of angular phase between the two embossing patterns of the two plies V1 and V2. The defect is more visible in FIG. 5G and less visible (almost not visible to the naked eye) in FIG. 5F. When, by analyzing the acquired image, the defect is detected, the control unit 30 can notify it to the operator through the user interface 33 and/or send a signal to any of the motors 35, 37 for changing the mutual angular phase of the two embossing rollers 4, 5. In practice, the control unit 30 can act on the motor of at least one of the embossing rollers 4, 5 to reduce the rotation speed by a suitable extent for a limited time.

The correct angular phase of the two embossing rollers 4, 5 can be checked (alternatively or in combination) also by comparing two images of the plies V1 and V2, acquired through coaxial cameras. In this case, in fact, superimposing the two acquired images makes any angular displacement immediately apparent, i.e. even before it is detected by putting over one another the protuberances embossed on the two plies V1 and V2, as shown in FIG. 5G. FIG. 5G clearly shows that, due to the lack of phase between the two embossing rollers 4, 5, and therefore the respective embossed plies V1, V2, the protrusions of a ply are no longer defined due to the crashing caused by the fact that they are not correctly put over the protrusions of the other ply.

In the description above, various types of defects have been described that can be detected through the vision units. In reality, two or more defects of different origin can simultaneously occur on the web material N, for example an insufficient (or excessive) embossing depth and a wrong angular displacement of embossing can occur at the same time. The vision units and the respective cameras with the processing units can be configured to detect more defects occurring simultaneously on the same web material. By processing the images through comparison thereof with reference images of web material devoid of defects, it is possible to obtain an indication about the percentage of probability that one or the other of more defects occurs.

The vision unit(s) 47, 49 described above can be configured in various ways, also based on the type of defect to be detected, the required accuracy of the detection and the required ability of distinguishing the defects.

For example, one or more of the following arrangements of cameras can be provided:
a single camera provided opposite the ply V1;
a single camera provided opposite the ply V2;
a series of cameras provided opposite the ply V1 to visualize one or more areas (for example two side areas along the longitudinal edges and possibly a central area) or even the whole width of the web material N;
a series of cameras provided opposite the ply V2 to visualize one or more areas (for example two side areas along the longitudinal edges and possibly a central area) or even the whole width of the web material N.

Based on the images acquired by the camera(s), the control unit 30 and/or the processing unit(s) 53A can detect the type of defect(s) by comparing the acquired images with one or more images representing the plies V1, V2 or the web material N devoid of defects. To achieve this, the control unit 30 and/or the processing unit(s) 53A can perform AI algorithms such as “deep learning”, neural networks or other adequate algorithms. Once the type of defect(s) has been identified, the control unit 30 can notify them to an operator through a graphic interface, so that the operator can promptly intervene to adjust the embossing device 1. To this end, the operator changes the setting of one or more functional units of the embossing device 1.

In this context, the term “functional unit” refers to any unit forming the embossing device 1, the setting of which can be changed, i.e. on which it is possible to perform an adjustment intervention, for example modifying one or more operating parameters.

A functional unit can be for example the embossing roller 4 with the respective rotation motor 35, or the embossing roller 5 with the respective rotation motor 37. Further functional units can be the embossing rollers 4, 5 with the motors 43, 44 for modifying the mutual inclination of the rotation axes 4X, 6X and 5X, 7X of the embossing rollers 4, 5 and of the respective pressure rollers 5, 7. A further functional unit can be for example any of the pressure rollers 6, 7 and the respective actuators 23, 24, or the lamination roller 11 and the respective actuator 28, or the functional fluid applicator 13 with the respective actuators adapted to change the arrangement or the position thereof, or the functional fluid flow rate.

In other words, a functional unit can be any actuator able to modify the configuration or setting of one or more members that are part of the embossing device 1.

Instead of, or in addition to notifying an anomalous operation to the operator, the control unit 30 can intervene directly on at least one of the functional units of the embossing device 1 to adjust, i.e. to change the settings of the functional unit and therefore of the embossing device 1. In this way, the embossing device 1 is constantly kept in conditions of optimal production, or aiming at conditions of optimal production.

If the control unit 30 is not able to constantly keep the embossing device 1 in optimal production conditions, or to recover the quality of the plies V1, V2 or of the web material N after the adjustment interventions, an alarm can be generated requiring the intervention of the operator, or the production can be stopped so as not to produce a significant amount of waste material. The control unit 30, when adapted to automatically adjust the embossing device 1, can perform self-learning algorithms, i.e. algorithms through which the control unit 30 learns, at least in an initial step, the adjustments to be performed based on the adjustments chosen by the operator for a given type of detected defect, or a combination of detected defects. Other known types of algorithms can be used without however departing from the scope of the invention.

1-33. (canceled)

34. An embossing device for producing an embossed web material including at least a first embossed cellulose ply; wherein the embossing device comprises:
a first embossing roller provided with a plurality of first embossing protuberances;
a first pressure roller that forms, with the first embossing roller, a first embossing nip, through which a first feed path for feeding a first cellulose ply passes; wherein a first actuator is adapted to press the first embossing roller and the first pressure roller against each other;
an exit path for an embossed web material including the first embossed cellulose ply; and
a first vision unit arranged along the exit path for the embossed web material and comprising a first camera adapted to detect defects in the embossed web material.

35. The embossing device of claim 34, comprising a second feed path for feeding a second cellulose ply, and a bonding arrangement for bonding the first embossed cellulose ply and the second cellulose ply to each other.

36. The embossing device of claim 35, comprising:
a second embossing roller provided with a plurality of second embossing protuberances; and
a second pressure roller that forms, with the second embossing roller, a second embossing nip, through which the second feed path passes; wherein a second actuator is adapted to press the second embossing roller and the second pressure roller against each other.

37. The embossing device of claim 35, wherein the bonding arrangement comprises a functional fluid applicator for bonding the first cellulose ply, fed through the first embossing nip, to the second cellulose ply, fed along the second feed path; wherein the functional fluid applicator co-acts with the first embossing roller; and wherein the embossing device further comprises a lamination nip adapted to receive the first embossed cellulose ply and the second cellulose ply and to bond the first embossed cellulose ply and the second cellulose ply together.

38. The embossing device of claim 37, wherein the lamination nip is formed between the first embossing roller and a lamination device comprising a lamination roller, and wherein the embossing device comprises a third actuator adapted to press the lamination device against the first embossing roller.

39. The embossing device of claim 34, wherein the first vision unit is provided opposite the first embossed cellulose ply to acquire images of the first embossed cellulose ply.

40. The embossing device of claim 34, further comprising a second vision unit provided along a web material exit path on a side opposite the first vision unit; wherein the second vision unit comprises a second camera adapted to detect defects in the embossed web material.

41. The embossing device of claim 40, wherein the first camera of the first vision unit and the second camera of the second vision unit are so aligned that a first optical axis of the first camera and a second optical axis of the second camera coincide.

42. The embossing device of claim 35, further comprising a second vision unit provided along a web material exit path on a side opposite the first vision unit; wherein the second vision unit comprises a second camera, adapted to detect defects in the embossed web material; and wherein the first vision unit and the second vision unit are arranged downstream of the bonding arrangement between the first cellulosic ply and the second cellulosic ply; the first vision unit being adapted to detect images of the first cellulosic ply and the second vision unit being adapted to detect images of the second cellulosic ply.

43. The embossing device of claim 34, wherein the first vision unit further comprises at least one lighting unit to illuminate an area of the web material framed by the first camera of the first vision unit.

44. The embossing device of claim 43, wherein the first vision unit further comprises two lighting units and wherein the first camera is provided in an intermediate position between the respective two lighting units.

45. The embossing device of claim 44, wherein the two lighting units of the first vision unit are so arranged as to generate light beams that are inclined with respect to the web material and converge towards one another in an area arranged opposite the first camera.

46. The embossing device of claim 44, wherein each of the two lighting units of the first vision unit comprises a lighting bar approximately parallel to the web material and directed according to a feed direction of the web material.

47. The embossing device of claim 40, wherein the second vision unit further comprises at least one lighting unit to illuminate an area of the web material framed by the second camera of the second vision unit.

48. The embossing device of claim 47, wherein the second vision unit further comprises two lighting units and wherein the second camera is provided in an intermediate position between the two lighting units.

49. The embossing device of claim 48, wherein the two lighting units of the second vision unit are so arranged as to generate light beams that are inclined with respect to the web material and converge towards one another in an area arranged opposite the second camera.

50. The embossing device of claim 47, wherein each of the two lighting units of the second vision unit comprises a lighting bar approximately parallel to the web material and directed according to a feed direction of the web material.

51. The embossing device of claim 34, wherein the first vision unit is contained in an opaque container having an inlet slot for the web material and an outlet slot for the web material.

52. The embossing device of claim 40, wherein the second vision unit is contained in an opaque container having an inlet slot for the web material and an outlet slot for the web material to exit.

53. The embossing device of claim 40, further comprising at least one control unit adapted:
to receive images from the first camera and/or the second camera;
to obtain, from said images, information on at least one embossing defect; and
to associate, to said at least one embossing defect, at least one malfunction factor of the embossing device, constituting cause of the embossing defect; and
to indicate, through a user interface, a corrective action for removing or reducing the at least one malfunction factor that causes the embossing defect; or
to generate at least one control for at least one functional unit of the embossing device, said control being adapted to reduce or to eliminate the embossing defect.

54. The embossing device of claim 53, wherein the at least one control is comprised in the group constituted by:
a control to vary pressure exerted, through the first actuator, between the first embossing roller and the first pressure roller in order to vary an embossing depth of the first cellulose ply;
a control to vary pressure exerted, through a second actuator, between a second embossing roller and a second pressure roller in order to vary an embossing depth of a second cellulose ply;
a control to vary pressure exerted, through a third actuator, between the first embossing roller and a lamination device;
a control to vary a crowning of at least one of the first embossing roller and a second embossing roller;
a control to vary, through a fourth actuator, an angle of mutual inclination between a rotation axis of the first embossing roller and a rotation axis of the first pressure roller;
a control to vary, through a fifth actuator, an angle of mutual inclination between a rotation axis of the second embossing roller and a rotation axis of the second pressure roller;
a control to vary an angular phase between the first embossing roller and the second embossing roller;
a control to vary distance between the first embossing roller and the second embossing roller;
a control to vary axial position of at least one of said first embossing roller and said second embossing roller.

55. The embossing device of claim 40, wherein the first camera and/or the second camera comprises, respectively, at least two cameras, positioned to frame respectively a lateral area along longitudinal edges of respectively the first cellulosic ply and/or a second cellulosic ply; wherein the first camera and/or the second camera comprises a further central camera, to frame an intermediate area of respectively the first cellulosic ply and the second cellulosic ply.

56. A method for producing a web material including at least a ply embossed by an embossing device; the method comprising steps as follows:
feeding a first cellulose ply along a first feed path through a first embossing nip between a first embossing roller, provided with a plurality of first embossing protuberances, and a first pressure roller; wherein the first embossing roller and the first pressure roller are pressed against each other by a first actuator;
feeding an embossed web material, including the first embossed cellulose ply, towards an exit path for the embossed web material;
acquiring images of the first embossed cellulose ply through a first vision unit that is provided along the exit path for the embossed web material and comprises a first camera, and checking if the first cellulosic ply includes an embossing defect.

57. The method of claim 56, further comprising:
feeding a second cellulose ply along a second feed path; and
bonding the first embossed cellulose ply and the second cellulose ply together in a mutual bonding arrangement.

58. The method of claim 57, further comprising:
feeding the second cellulose ply through a second embossing nip between a second embossing roller, provided with a plurality of second embossing protuberances, and a second pressure roller; wherein the second embossing roller and the second pressure roller are pressed against each other by a second actuator; and
embossing the second cellulose ply before bonding said second cellulose ply to the first cellulose ply.

59. The method of claim 57, further comprising:
applying, through a functional fluid applicator, a functional fluid to embossed areas of the first cellulose ply that adheres to the first embossing roller downstream of the first embossing nip; and
bonding, in a lamination nip, the first embossed cellulose ply and the second cellulose ply together and forming the embossed web material.

60. The method of claim 59, wherein the lamination nip is formed between the first embossing roller and a lamination device comprising a lamination roller, and wherein the lamination device and the first embossing roller are pressed against each other by a third actuator.

61. The method of claim 56, wherein the first vision unit is provided opposite the first embossed cellulose ply so as to acquire images of said first embossed cellulose ply.

62. The method of claim 56, further comprising acquiring images of the embossed web material through a second vision unit provided along the web material exit path, on a side opposite the first vision unit; wherein the second vision unit comprises a second camera.

63. The method of claim 62, wherein the first camera of the first vision unit and the second camera of the second vision unit are so aligned that a first optical axis of the first camera and a second optical axis of the second camera match.

64. The method of claim 57, further comprising acquiring images of the embossed web material through a second vision unit provided along the web material exit path, on the side opposite the first vision unit; wherein the second vision unit comprises a second camera; and wherein the first vision unit is arranged opposite the first embossed cellulosic ply to detect images of the first embossed cellulosic ply; and the second vision unit is arranged opposite the second cellulosic ply to detect images of the second cellulosic ply, downstream of the bonding arrangement.

65. The method of claim 56, further comprising obtaining, from the images, information on existence of any embossing defect and furthermore:
signaling, through a user interface, existence of a defect and giving indication on kind of defect and probable origin thereof; or generating at least one control for the embossing device, said at least one control being adapted to cause an intervention on a functional unit of the embossing device aiming at reducing or eliminating the defect.

66. The method of claim 65, wherein the at least one control is selected from a group constituted by:
a control to vary pressure exerted, through the first actuator, between the first embossing roller and the first pressure roller in order to vary an embossing depth of the first cellulose ply;
a control to vary pressure exerted, through a second actuator, between a second embossing roller and a second pressure roller in order to vary an embossing depth of the first cellulose ply;
a control to vary pressure exerted, through a third actuator, between the first pressure roller and a lamination device;
a control to vary a crowning of at least one of the first embossing roller and the second embossing roller;
a control to vary, through a fourth actuator, an angle of mutual inclination between a rotation axis of the first embossing roller and a rotation axis of the first pressure roller;
a control to vary, through a fifth actuator, an angle of mutual inclination between a rotation axis of the second embossing roller and a rotation axis of the second pressure roller;
a control to vary an angular phase between the first embossing roller and the second embossing roller;
a control to vary distance between the first embossing roller and the second embossing roller;
a control to vary axial position of at least one of the first embossing roller and the second embossing roller.
